(19) United States
(12) Patent Application Publication
(10) Pub. No.: US 2020/0205115 A1
(43) Pub. Date: Jun. 25, 2020

(54) WIRELESS POSITIONING METHOD AND SYSTEM USING THE SAME

(71) Applicant: UBTECH ROBOTICS CORP LTD, Shenzhen (CN)

(72) Inventors: Yongsheng Zhao, Shenzhen (CN); Youjun Xiong, Shenzhen (CN); Zhanjia Bi, Shenzhen (CN); Jianxin Pang, Shenzhen (CN)

(21) Appl. No.: 16/396,692

(22) Filed: Apr. 28, 2019

(30) Foreign Application Priority Data
Dec. 25, 2018 (CN) 201811591563.7

(51) Int. Cl. H04W 64/00; G01S 5/14; G01S 11/08

(52) U.S. Cl. CPC H04W 64/003; G01S 11/08; G01S 5/14

(57) ABSTRACT

The present disclosure provides wireless positioning methods and a system using the same. One of the method includes: broadcasting a ranging request frame to at least two of the positioning anchors and recording a first timestamp of broadcasting the ranging request frame, if a positioning request is detected; receiving a ranging reply frame corresponding to the ranging request frame from each of the at least two positioning anchors and recording a second timestamp of receiving the ranging reply frame; calculating a distance between the positioning anchor and the positioning tag transmitting the ranging request frame based on the first timestamp, the second timestamp, and the time difference; and determining position information of the positioning tag based on the anchor information and the distance. In the above-mentioned manner, the tag can determine the position information of the tag by broadcasting once.

### CROSS REFERENCE TO RELATED APPLICATION PROGRAMS

This application claims priority to Chinese Patent Application No. CN201811591563.7, filed Dec. 25, 2018, which is hereby incorporated by reference herein as if set forth in its entirety.

### BACKGROUND

### 1. Technical Field

The present disclosure relates to communication technology, and particularly to a wireless positioning method and system using the same.

### 2. Description of Related Art

At present, wireless positioning systems are a type of positioning system which are more common. A general wireless positioning system includes two parts: positioning tags and anchors (i.e., base stations). A positioning tag is a mobile device installed on a target to be positioned, and an anchor is a device fixedly installed at a place or being on a location-computable motion track.

In the existing wireless positioning system, the positioning tag measures the distance with respect to the anchor periodically, and calculates the position of the positioning tag through the ranging value and the coordinate of the anchor. However, in the process of ranging, the positioning tag generally have to perform 3-4 times of wireless communication with one anchor, and it generally needs to perform ranging with 3-5 anchors per positioning, hence the positioning tag needs to perform 10-20 times of wireless communications per positioning. This kind of positioning methods need many times of wireless communications, which have much time consumption and there is much power consumption on the positioning tag.

### BRIEF DESCRIPTION OF THE DRAWINGS

To describe the technical schemes in the embodiments of the present disclosure more clearly, the following briefly introduces the drawings required for describing the embodiments or the prior art. Apparently, the drawings in the following description merely show some examples of the present disclosure. For those skilled in the art, other drawings can be obtained according to the drawings without creative efforts.

FIG. 1 is a flow chart of an embodiment of a wireless positioning method according to the present disclosure.

FIG. 2 is a schematic diagram of an application scenario of the wireless positioning method of FIG. 1.

FIG. 3 is a flow chart of another embodiment of a wireless positioning method according to the present disclosure.

FIG. 4 is a schematic block diagram of an embodiment of a positioning tag according to the present disclosure.

FIG. 5 is a schematic block diagram of an embodiment of a positioning anchor according to an embodiment of the present disclosure.

FIG. 6 is a schematic block diagram of an embodiment of a wireless positioning system according to the present disclosure.

### DETAILED DESCRIPTION

In the following descriptions, for purposes of explanation instead of limitation, specific details such as particular system architecture and technique are set forth in order to provide a thorough understanding of embodiments of the present disclosure. However, it will be apparent to those skilled in the art that the present disclosure may be implemented in other embodiments that are less specific of these details. In other instances, detailed descriptions of well-known systems, devices, circuits, and methods are omitted so as not to obscure the description of the present disclosure with unnecessary detail.

For the purpose of describing the technical solutions of the present disclosure, the following describes through specific embodiments.

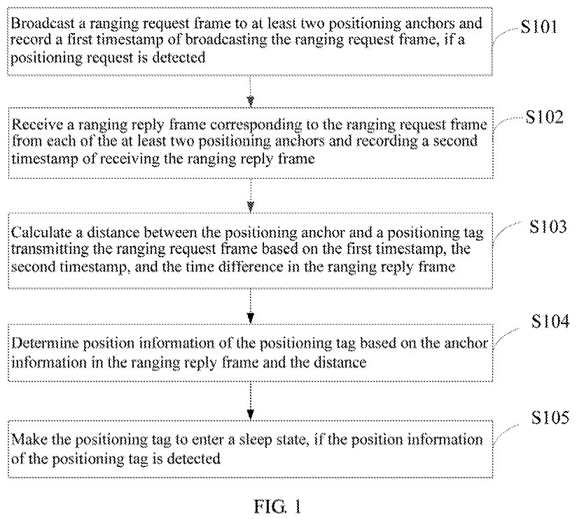

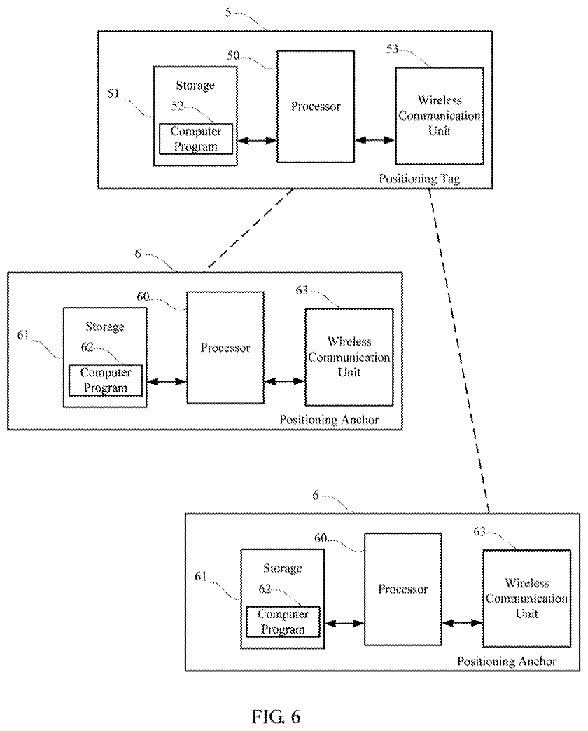

FIG. 1 is a flow chart of an embodiment of a wireless positioning method according to present disclosure. In this embodiment, a wireless positioning method for a positioning tag in a wireless positioning system (see FIG. 6) having at least a positioning tag and a plurality of positioning anchor (i.e., base stations) is provided. In which, the positioning tag includes a wireless communication unit such as a UWB RF (ultra-wideband radio frequency) module for communicating with the plurality of positioning anchors. The method is a computer-implemented method executable for a processor of the positioning tag. As shown in FIG. 1, the method includes the following steps.

S101: broadcasting, by the positioning tag, a ranging request frame to at least two of the positioning anchors and recording, by the positioning tag, a first timestamp of broadcasting the ranging request frame, if a positioning request is detected.

In this embodiment, the tag is a mobile device to be positioned in the wireless positioning system. In an application scenario, the tag can generally be a work card, a bracelet, wristband, a mobile terminal, and the like. The positioning anchor is a fixedly installed device in the wireless positioning system, which is a type of radio station and refers to a radio transceiver station that transmits information to and from each terminal device (e.g., a tag and an anchor) in a specific radio coverage area through a communication switching center.

When the tag has detected the positioning request, it broadcasts the ranging request frame to at least two positioning anchors for positioning. For instance, the positioning request may be triggered by executing a timed task, performed by the user through clicking a “positioning” virtual button on an interface of the tag, or generated by the user through receiving a remote device positioning instruction, which is not limited herein.

The tag broadcasts the ranging request frame to the at least two positioning anchors for positioning. In which, broadcasting is the most common form of multi-drop delivery, which delivers a copy of a packet to each target anchor. The broadcasting can be performed by multiple deliveries of a packet, or by delivering copies of the packet through individual connections until each receiving part receives one copy, that is, the tag transmits the ranging request frame to the positioning anchors for positioning through only one broadcasting.

In this embodiment, the amount of the positioning anchor for positioning is at least two or more, which is not limited herein. If the position of the tag is on a same line as the positions of the positioning anchors, position information of the tag can be determined based on the positions of at least two positioning anchors and the distances between two positioning anchors and the tag; if the position of the tag is not on the same line as the positions of the positioning anchors, the position information of the tag can be determined based on the positions of at least three positioning anchors and the distances between two positioning anchors and the tag; and if the position of the tag is not on the same line as the positions of the positioning anchors and the position information of the tag including an altitude, the position information of the tag can be determined based on the positions of at least four positioning anchors and the distances between two positioning anchors and the tag.

The tag encapsulates ranging request related data into ranging request frames, where a ranging request frame is a data frame. A data frame refers to a protocol data unit of the data link layer, which includes three parts: a frame header, a data portion, and a frame tail. In which, the frame header and the frame tail include some necessary control information such as synchronization information, address information, and error control information; and the data portion includes data received from the network layer such as data packets.

A timestamp is a complete and verifiable data for representing that a piece of data is existed before a specific time, which is usually a sequence of characters that uniquely identifies a moment. The tag records the time at which the ranging request frame is transmitted, that is, the first timestamp.

S102: receiving, by the positioning tag, a ranging reply frame corresponding to the ranging request frame from each of the at least two positioning anchors and recording, by the positioning tag, a second timestamp of receiving the ranging reply frame, where the ranging reply frame includes anchor information of the positioning anchor and a time difference between the positioning anchor to receive the ranging request frame and the positioning anchor to transmit the ranging reply frame.

Since the ranging reply frame will be returned based on the ranging request frame after the positioning anchor receives the ranging request frame broadcasted by the tag, the tag receives the ranging reply frame returned by each positioning anchor based on the ranging request frame, where the ranging reply frame is a digital frame including a frame header, a data portion, and a frame tail, and the data portion includes information to be included in the ranging reply frame. The ranging reply frame may include the anchor information of the positioning anchor and the time difference between the positioning anchor to receive the ranging request frame and the positioning anchor to transmit the ranging reply frame.

The anchor information of the positioning anchor is information related to the positioning anchor itself which is stored in the positioning anchor, which may include coordinate information of the positioning anchor, and may include identifier information of the positioning anchor, for example, the ID number of the positioning anchor. Since the positioning anchor will process the data in the ranging request frame and encapsulate the ranging reply frame after receiving the ranging request frame broadcasted by the tag, there will be a time difference between the positioning anchor to receive the ranging request frame and the positioning anchor to transmit the ranging reply frame.

The tag records the time at which each ranging request frame is received, that is, the second timestamp.

S103: calculating, by the positioning tag, a distance between the positioning anchor and the positioning tag transmitting the ranging request frame based on the first timestamp, the second timestamp, and the time difference in the ranging reply frame.

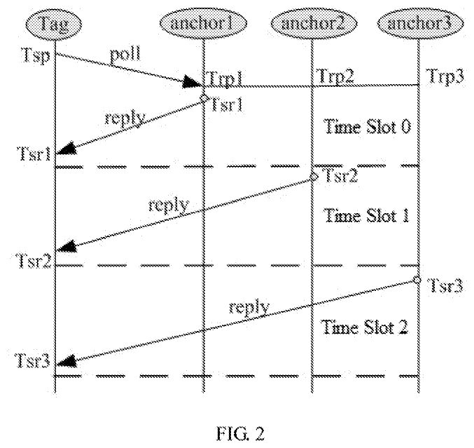

FIG. 2 is a schematic diagram of an application scenario of the wireless positioning method of FIG. 1. As shown in FIG. 2, the tag calculates, a time for transmitting the ranging request frame and the ranging reply frame between the tag and the positioning anchor based on the first timestamp Tsp, the second timestamp Tsr, and the time difference in the ranging reply frame. Since the ranging request frame and the ranging reply frame are both digital frames, and the digital frames are transmitted in the air in the form of wireless signals, the distance between the positioning anchor and the tag transmitting the ranging request frame can be calculated when the time for the wireless signal between the positioning anchor and the tag transmitting the ranging request frame to be transmitted in the air and the speed of the transmission is known. Since signal are propagated at the speed of light in the air, the speed at which the wireless signal between the positioning anchor and the tag transmitting the ranging request frame to be transmitted in the air is the speed of light, and the distance between the positioning anchor and the tag transmitting the ranging request frame can be calculated by the following formula:

d=(Tsr−Tsp−(Tsq−Trp))×C/2

where, d is the distance between the positioning anchor and the tag transmitting the ranging request frame; (Tsq−Trp) is the time difference between the positioning anchor to receive the ranging request frame and the positioning anchor to transmit the ranging reply frame; Tsr is the second timestamp; and Tsp is the first timestamp; (Tsr−Tsp−(Tsq−Trp)) is the time for the wireless signal between the positioning anchor and the tag transmitting the ranging request frame to be transmitted in the air; and C is the speed of light. Because the wireless signal is transmitted for two distances of the transmission and the reception between the positioning anchor and the tag transmitting the ranging request frame, what obtained by multiplying the time for the wireless signal to be transmitted in the air and the speed of light is the distance of the two wireless signals between the positioning anchor and the tag transmitting the ranging request frame to be transmitted. In this way, an average value is obtained through two transmissions, and the accuracy of the ranging is improved.

Furthermore, in order to make a target positioning anchor or a server in the wireless positioning system to be capable of obtaining the position information of the tag, the method may further include the following step after S103: transmitting, by the positioning tag, the anchor information of the positioning anchor and the distance to one of a positioning anchor or a server in the wireless positioning system, where the anchor information of the positioning anchor and the distance are for determining the position information of the positioning tag.

The tag transmits the anchor information of the positioning anchor and the distance to the target positioning anchor, such that the target positioning anchor can calculate the position information of the positioning tag based on the anchor information of the positioning anchor and the distance when the target positioning anchor obtains the anchor information of the positioning anchor and the distance which are transmitted by the positioning tag. In which, the target positioning anchor is a positioning anchor that needs to obtain the position information of the tag, and the anchor information of the positioning anchor at least includes the anchor information of all the positioning anchors except the target positioning anchor, where the anchor information includes the position information of the anchor or the identifier information of the anchor.

The tag transmits the anchor information of the positioning anchor and the distance to the server, such that the server can calculate the position information of the positioning tag based on the anchor information of the positioning anchor and the distance when the server obtains the anchor information of the positioning anchor and the distance which are transmitted by the positioning tag. In which, the anchor information includes the position information of all the anchors or the identifier information of all the anchor.

S104: determining, by the positioning tag, position information of the positioning tag based on the anchor information in the ranging reply frame and the distance.

The tag determines the coordinate of the anchor based on the anchor information in the ranging reply frame, where the anchor information may include a coordinate of the anchor and identifier of the anchor. When the anchor information includes the coordinate of the anchor, the tag may directly obtain the coordinate of the anchor from the anchor information; when the anchor information includes the anchor identifier, the tag pre-stores a preset relationship between the anchor identifier and the coordinate of the anchor, obtains the anchor identifier based on the anchor information, and determines the coordinate of the anchor based on the pre-stored preset relationship between the anchor identifier and die coordinate of the anchor.

The coordinate system in which the positioning anchor is located is a coordinate system established by using a reference point related to the position of the anchor as a coordinate origin, and the coordinate of the anchor in the coordinate system is the coordinate of the anchor. Those skilled in the art should understand that, in the process of establishing the coordinate system, any fixed object in the environment can be used as a reference, and which one of the objects in the environment is selected as the reference can be determined according to the position of the tag. In this embodiment, the coordinate may be a planar two-dimensional coordinate system, or may be a spatial three-dimensional coordinate system, which can be established according to the actual position of the tag and the anchor, and is not limited herein.

The position of the anchor which is determined based on the anchor information may be represented by a coordinate, or by latitude and longitude. For instance, it can obtain circles by using the positioning anchor as a center and the distance between the tag and the positioning anchor as a radius, and the intersection of all the circles is the position of the tag, and then calculate the position information of the tag. In which, the position information of the tag can be expressed in the form of coordinate or in the form of latitude and longitude, which is not limited herein.

Furthermore, in order to accurately determine the position information of the tag when there are three target anchors and the three target anchors are not on a same line, step S104 may include the following step when there are three target anchors and the three target anchors are not on the same line: calculating, by the positioning tag, the position information of the positioning tag based on the anchor information in the ranging reply frame and the distance through a triangulation method.

In actual applications, in most cases, the target anchors and the tag are all located at a same level, and the target anchors are not on a same line. Hence, in this embodiment, for the case that there are three target anchors and the three target anchors are not on the same line, the position information of the tag can he calculated based on the anchor information and the distance by using the triangulation method.

The triangulation method is a positioning algorithm. In which, there are known positions (x₁, y₁), (x₂, y₂), (x₃, y₃) of three points and known distances d₁, d₂, d₃ from an unknown point (x0, y0) to the three points. By using the distances d₁, d₂, d₃ as the radius to make three circles, according to the Pythagorean theorem, the formula for calculating the position of the intersection point, that is, the unknown point is as follows:

(x₁−x₀)²+(y₁−y₀)²=d₁²;

(x₂−x₀)²+(y₂−y₀)²=d₂²;

(x₃−x₀)²+(y₃−y₀)²=d₃².

Based on the above-mentioned formula, the position of the unknown point (x₀, y₀) can be determined, where the position of the tag is the position of the unknown point in the formula, and the positions of the anchors are the known positions of the three points.

In an actual positioning, there will inevitably be an error. For given distances, due to the error of measurements, there may be a case that the three circles cannot intersect at one point. At this time, it can draw a rectangle in the intersection area to calculate the position of the center of the rectangle, and then take the center of the rectangle as the position of the tag.

Furthermore, in this embodiment, in order to further reduce the power consumption of the tag, the method may further include the following step.

S105: making the positioning tag to enter a sleep state, if the position information of the positioning tag is detected.

When the tag has detected that the position information is obtained, the tag is determined to have completed the positioning, then the tag is in a non-transmission state and enters the steep state. The tag in the sleep state has low power consumption, which has a larger duty ratio and the battery life is extended. As a result, the utilization of resources is high, and the capacity of the system is also increased.

In this embodiment, the wireless positioning method includes: broadcasting, by the positioning tag, a ranging request frame to at least two of the positioning anchors and recording, by the positioning tag, a first timestamp of broadcasting the ranging request frame, if a positioning request is detected; receiving, by the positioning tag, a ranging reply frame corresponding to the ranging request frame from each of the at least two positioning anchors and recording, by the positioning tag, a second timestamp of receiving the ranging reply frame, where the ranging reply frame comprises anchor information of the positioning anchor and a time difference between the positioning anchor to receive the ranging request frame and the positioning anchor to transmit the ranging reply frame; calculating, by the positioning tag, a distance between the positioning anchor and the positioning tag transmitting the ranging request frame based on the first timestamp, the second timestamp, and the time difference in the ranging reply frame; and determining, by the positioning tag, position information of the positioning tag based on the anchor information in the ranging reply frame and the distance. In the above-mentioned manner, the tag can determine the position information of the tag by broadcasting once and receiving the ranging reply frame of the plurality of positioning anchors, which reduces the amount of wireless communications, saves the time of positioning, and reduces the power consumption of the positioning tag.

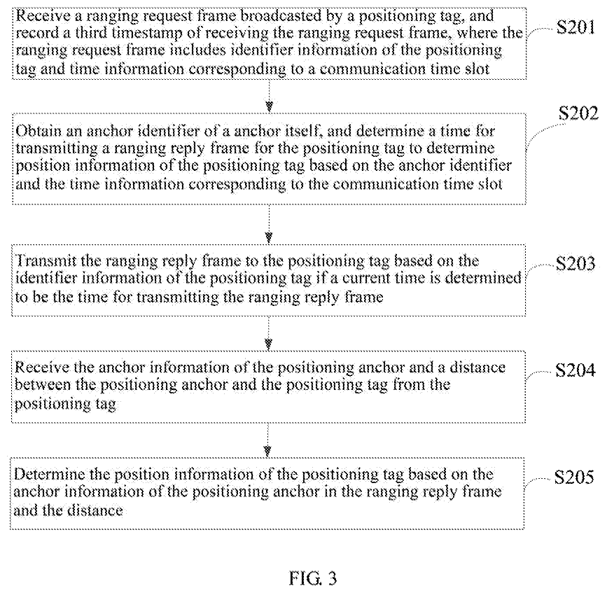

FIG. 3 is a flow chart of another embodiment of a wireless positioning method according to the present disclosure. In this embodiment, a wireless positioning method for a positioning anchor in a wireless positioning system having at least a positioning tag and a plurality of positioning anchors is provided. The positioning anchor is a fixedly installed device in the wireless positioning system, which is a type of radio station and refers to a radio transceiver station including a wireless communication unit such as a UWB RF module for transmitting information to and from each terminal device (e.g., a tag and an anchor) in a specific radio coverage area. The method is a computer-implemented method executable for a processor of the positioning anchor. As shown in FIG. 3, the method includes the following steps.

S201: receiving, by the positioning anchor, a ranging request frame broadcasted by the positioning tag, and recording, by the positioning anchor, a third timestamp of receiving the ranging request frame, where the ranging request frame includes identifier information of the positioning tag and time information corresponding to a communication time slot.

The positioning anchor receives the ranging request frame broadcasted by the positioning tag, where the ranging request frame is a data frame which includes three parts: a frame header, a data portion, and a frame tail. In which, the frame header and the frame tail include some necessary control information such as synchronization information, address information, and error control information; and the data portion includes data received from the network layer such as data packets. The identifier information of the positioning tag and the time information corresponding to the communication time slot may be included in the data portion of the ranging request frame. When the anchor receives the ranging request frame, it obtains the identifier information of the positioning tag and the time information corresponding to the communication time slot which are included in the ranging request frame from the ranging request frame.

In which, the identifier information of the positioning tag is for the anchor to confirm the communicated tag in the positioning, and the time information includes the duration of the communication time slot which is preset in the tag. In the preset communication time slot, the anchor can transmit complete signals to the positioning tag while the positioning tag can receive the signals transmitted by the anchor completely, and the data carried in the signals can be transmitted intactly between the positioning anchor and the positioning tag.

Since signals are propagated in the air at the speed of light, the times for different positioning anchors to transmit signals to the same tag will not vary largely. Hence, all the communication time slots for the signal transmissions between different positioning anchors and the same tag are the same. In this embodiment, the preferred duration of the communication time slot is 0.7 milliseconds, that is, if the duration of the communication time slot is less than 0.7 milliseconds, the signals transmitted between the positioning anchors and the positioning tag will be affected, and the integrity of the signals cannot be guaranteed. Those skilled in the art can understand that, although the recommended duration of the communication time slot is 0.7 milliseconds, in an actual application, the duration of the communication rime slots can be greater than 0.7 milliseconds. However, it can be understood that, the smaller the communication time slot is, the shorter the time for the anchor and the positioning tag to work in the positioning process, and the smaller the power consumption of the positioning tag.

A timestamp is a complete and verifiable data for representing that a piece of data is existed before a specific time, which is usually a sequence of characters that uniquely identifies a moment. The positioning anchor records the time at which the ranging request frame is received, that is, the third timestamp.

S202: obtaining, by the positioning anchor, an anchor identifier of the anchor itself, and determining, by the positioning anchor, a time for transmitting a ranging reply frame for the positioning tag to determine position information of the positioning tag based on the anchor identifier and the lime information corresponding to the communication time slot.

The positioning anchor obtains its own anchor identifier, where the anchor identifier of the positioning anchor itself may be a preset anchor ID number. Based on the anchor identifier of the positioning anchor itself and a preset rule, it can determine the communication time slot that the anchor uses to transmit the ranging reply frame. For instance, referring to FIG. 2, if there are N positioning anchors, it can allocate the communication time slot that the anchor uses to transmit the ranging reply frame according to the ID number of the anchor. As an example, the communication time slot that the anchor uses to transmit the ranging reply frame can be determined according to the remainder of the ID number divided by N. When setting the ID number of the positioning anchor, it can be set according to a mathematical rule so as to avoid the situation that two positioning anchors simultaneously transmit signals in the same time slot.

After determining the communication time slot that the anchor uses to transmit the ranging reply frame, the time at which the anchor transmits the ranging reply frame is determined according to the duration of the communication time slot.

S203: transmitting, by the positioning anchor, the ranging reply frame to the positioning tag based on the identifier information of the positioning tag if a current time is determined to be the time for transmitting the ranging reply frame, where the ranging reply frame includes anchor information of the positioning anchor itself, the third timestamp, a fourth timestamp of transmitting the ranging reply frame, and a time difference between the fourth timestamp and the third timestamp.

The tag for the anchor to return the ranging reply frame is determined based on the identifier information of the tag. If the anchor determines that the current time is the time for transmitting the ranging reply frame, it returns the ranging reply frame to the tag corresponding to the identifier information of the tag. In which, the ranging reply frame includes: the anchor information of the positioning anchor itself, the third timestamp, the fourth timestamp of transmitting the ranging reply frame, and the time difference between the fourth timestamp and the third timestamp. The ranging reply frame is for the positioning tag to determine the position information of the positioning tag.

In which, the anchor information may include a coordinate of the anchor and identifier of the anchor. When the anchor information includes the coordinate of the anchor, the tag may directly obtain the coordinate of the anchor from the anchor information; when the anchor information includes the anchor identifier, the tag pre-stores a preset relationship between the anchor identifier and the coordinate of the anchor obtains the anchor identifier based on the anchor information, and determines the coordinate of the anchor based on the pre-stored preset relationship between the anchor identifier and the coordinate of the anchor.

Since the positioning anchor will process the data in the ranging request frame and encapsulate the ranging reply frame after receiving the ranging request frame broadcasted by the tag, there will be a lime difference between the positioning anchor to receive the ranging request frame and the positioning anchor to transmit the ranging reply frame, that is, the time difference between the fourth timestamp and the third timestamp. During the period corresponding to the time difference, the positioning anchor processes the data in the ranging request frame and encapsulates the ranging reply frame.

Furthermore, in order to enable the target positioning anchor or the server to obtain the position information of the tag, after step S203, the method may further include the following steps.

S204: receiving, by the positioning anchor, the anchor information of the positioning anchor and a distance between the positioning anchor and the positioning tag from the positioning tag.

The positioning anchor receives the anchor information of the positioning anchor and the distance between the positioning anchor and the positioning tag which are transmitted by the positioning tag. In which, the positioning anchor is a positioning anchor that needs to obtain the position information of the tag, and the anchor information of the positioning anchor at least includes the anchor information of all the positioning anchors except this positioning anchor, where the anchor information includes the position information of the anchor or the identifier information of the anchor.

S205: determining, by the positioning anchor, the position information of the positioning tag based on the anchor information of the positioning anchor in the ranging reply frame and the distance.

The positioning anchor determines the coordinate of the positioning anchor based on the anchor information, where the anchor information may include a coordinate of the anchor and identifier of the anchor. When the anchor information includes the coordinate of the anchor, the anchor may directly obtain the coordinate of the anchor from the anchor information; when the anchor information includes the anchor identifier, the anchor pre-stores a preset relationship between the anchor identifier and the coordinate of the anchor, obtains the anchor identifier based on the anchor information, and determines the position information of the positioning anchor such as the coordinate of the anchor based on the pre-stored preset relationship between the anchor identifier and the coordinate of the anchor.

The coordinate system in which the positioning anchor is located is a coordinate system established by using a reference point related to the position of the anchor as a coordinate origin, and the coordinate of the anchor in the coordinate system is the coordinate of the anchor. Those skilled in the art should understand that, in the process of establishing the coordinate system, any fixed object in the environment can be used as a reference, and which one of the objects in the environment is selected as the reference can be determined according to the position of the tag. In this embodiment, the coordinate may be a planar two-dimensional coordinate system, or may be a spatial three-dimensional coordinate system, which can be established according to the actual position of the tag and the anchor, and is not limited herein.

The position of the anchor which is determined based on the anchor information may be represented by a coordinate, or by latitude and longitude. For instance, it can obtain circles by using the positioning anchor as a center and the distance between the tag and the positioning anchor as a radius, and the intersection of all the circles is the position of the tag, and then calculate the position information of the tag. In which, the position information of the tag can be expressed in the form of coordinate or in the form of latitude and longitude, which is not limited herein.

In this embodiment, the wireless positioning method includes: receiving, by the positioning anchor, a ranging request frame broadcasted by the positioning tag, and recording, by the positioning anchor, a third timestamp of receiving the ranging request frame, where the ranging request frame comprises identifier information of the positioning tag and time information corresponding to a communication time slot; obtaining, by the positioning anchor, an anchor identifier of the anchor itself, and determining, by the positioning anchor, a time for transmitting a ranging reply frame for the positioning tag to determine position information of the positioning tag based on the anchor identifier and the time information corresponding to the communication time slot; and transmitting, by the positioning anchor, the ranging reply frame to the positioning tag based on the identifier information of the positioning tag if a current time is determined to be the time for transmitting the ranging reply frame, where the ranging reply frame comprises anchor information of the positioning anchor itself, the third timestamp, a fourth timestamp of transmitting the ranging reply frame, and a time difference between the fourth timestamp and the third timestamp. In the above-mentioned manner, the anchor receives the ranging request frame broadcasted by the positioning tag and returns the ranging reply frame with a delay, so that the positioning tag can determine the position information of the positioning tag based on the ranging reply frame, which reduces the amount of the communications between the anchor and the tag during the process of determining the position information of the tag, saves the communication time, and reduces the power consumption of the positioning tag.

It should be understood that, the sequence of the serial number of the steps in the above-mentioned embodiments does not mean the execution order while the execution order of each process should be determined by its function and internal logic, which should not be taken as any limitation to the implementation process of the embodiments.

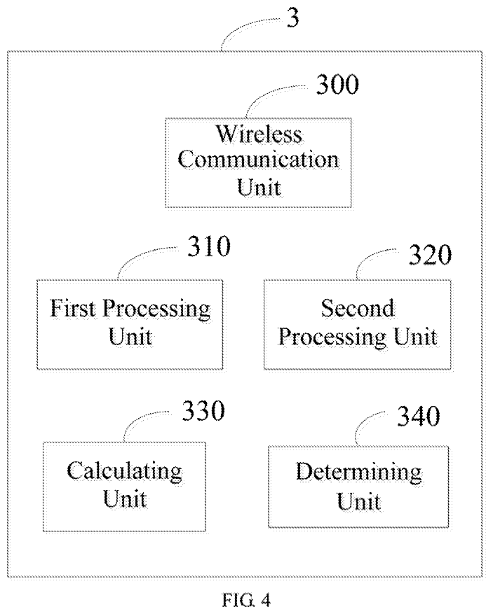

FIG. 4 is a schematic block diagram of an embodiment of a positioning tag according to the present disclosure. In this embodiment, a positioning tag for a wireless positioning system (see FIG. 6) having at least a positioning tag and a plurality of positioning anchors is provided. For the convenience of explanation, only the parts related to this embodiment are shown. As shown in FIG. 4, a positioning tag 3 includes:

a wireless communication unit 300 configured to communicate with the plurality of positioning anchors in the wireless positioning system;

a first processing unit 310 configured to broadcast a ranging request frame to at least two of the positioning anchors and record a first timestamp of broadcasting the ranging request frame;

a second processing unit 320 configured to receive a ranging reply frame corresponding to the ranging request frame from each of the at least two positioning anchors and record a second timestamp of receiving the ranging reply frame, where the ranging reply frame includes anchor information of the positioning anchor and a time difference between the positioning anchor to receive the ranging request frame and the positioning anchor to transmit the ranging reply frame;

a calculating unit 330 configured to calculate a distance between the positioning anchor and the positioning tag transmitting the ranging request frame based on the first timestamp, the second timestamp, and the time difference in the ranging reply frame; and

a determining unit 340 configured to determine position information of the positioning tag based on the anchor information in the ranging reply frame and the distance.

In this embodiment, the wireless communication unit 300 is a circuit such as a UWB RF module. The first processing unit 31, the second processing unit 320, the calculating unit 330, and the determining unit 340 are implemented in the form of software, which can be computer program(s) stored in a memory of the positioning tag 3 and executable on a processor of the positioning tag 3. In other embodiments, the first processing unit 31, the second processing unit 320, the calculating unit 330, and the determining unit 340 may be implemented in the form of hardware (e.g., a circuit of the positioning tag 3 which is coupled to the processor of the positioning tag 3) or a combination of hardware and software (e.g., a circuit with a single chip microcomputer).

Furthermore, when there are three target anchors and the three target anchors are not on a same line, the determining unit 340 is further configured to:

calculate the position information of the positioning tag based on the anchor information in the ranging reply frame and the distance through a triangulation method.

Furthermore, the positioning tag 3 further includes:

a transmitting unit configured to transmit the anchor information of the positioning anchor and the distance to the positioning anchor or a server of the wireless positioning system, where the anchor information of the positioning anchor and the distance are for determining the position information of the positioning tag.

Furthermore, the positioning tag 3 further includes:

a third processing unit configured to make the positioning tag to enter a sleep state, if the position information of the positioning tag has detected.

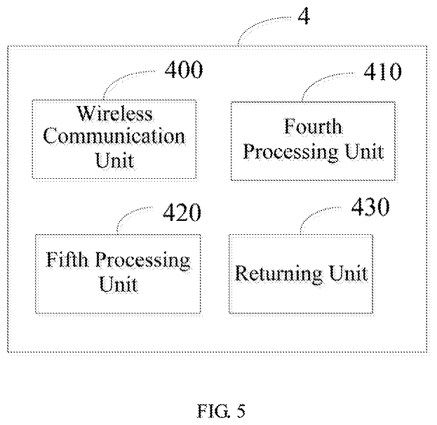

FIG. 5 is a schematic block diagram of an embodiment of a positioning anchor according to an embodiment of the present disclosure. In this embodiment, an anchor (i.e., a base station) for a wireless positioning system (see FIG. 6) having at least a positioning tag and a plurality of positioning anchors is provided. For the convenience of explanation, only the parts related to this embodiment are shown. As show n in FIG. 5, the positioning anchor 4 includes:

a wireless communication unit 400 configured to communicate with the positioning tag in the wireless positioning system;

a fourth processing unit 410 configured to receive a ranging request frame broadcasted by the positioning tag, and recording a third timestamp of receiving the ranging request frame, where the ranging request frame includes identifier information of the positioning tag and time information corresponding to a communication time slot;

a fifth processing unit 420 configured to obtain an anchor identifier of the anchor itself, and determining a time for transmitting a ranging reply frame for the positioning tag to determine position information of the positioning tag based on the anchor identifier and the time information corresponding to the communication time slot; and

a returning unit 430 configured to transmit the ranging reply frame to the positioning tag based on the identifier information of the positioning tag if a current time is determined to be the time for transmitting the ranging reply frame, where the ranging reply frame includes anchor information of the positioning anchor itself, the third timestamp, a fourth timestamp of transmitting the ranging reply frame, and a time difference between the fourth timestamp and the third timestamp.

In this embodiment, the wireless communication unit 400 is a circuit such as a UWB RF module. The fourth processing unit 410, the fifth processing unit 420, and the returning unit 430 are implemented in the form of software, which can be computer program(s) stored in a memory of the positioning anchor 4 and executable on a processor of the positioning anchor 4. In other embodiments, the fourth processing unit 410, the fifth processing unit 420. and the returning unit 430 may be implemented in the form of hardware (e.g., a circuit of the positioning anchor 4 which is coupled to the processor of the positioning anchor 4) or a combination of hardware and software (e.g., a circuit with a single chip microcomputer).

Furthermore, the positioning anchor 4 further includes:

a receiving unit configured to receive anchor information of the positioning anchor sent by the positioning tag, a distance between the positioning anchor and the positioning tag; and

a determining unit configured to determine position information of the positioning tag based on the anchor information in the ranging reply frame of the positioning anchor and the distance.

FIG. 6 is a schematic block diagram of an embodiment of a wireless positioning system according to the present disclosure. As shown in FIG. 6, in this embodiment, a wireless positioning system includes at least a positioning tag 5 and a plurality of positioning anchors 6. The positioning tag 5 includes a processor 50, a memory 51, and a computer program 52 stored in the memory 51 and executable on the processor 50, for example, a wireless positioning program, and a wireless communication unit 53 (e.g., a UWB RF module) for communicating with the plurality of positioning anchors 6. When executing (instructions in) the computer program 52, the processor 50 implements the steps in the above-mentioned embodiments of the wireless positioning method, for example, steps S101-S104 shown in FIG. 1. Alternatively, when the processor 50 executes the (instructions in) computer program 52, the functions of each module/unit in the above-mentioned device embodiments, for example, the functions of the modules 310-340 shown in FIG. 4 are implemented.

Exemplarily, the computer program 52 may be divided into one or more modules/units, and the one or more modules/units are stored in the storage 51 and executed by the processor 50 to realize the present disclosure. The one or more modules/units may be a series of computer program instruction sections capable of performing a specific function, and the instruction sections are for describing the execution process of the computer program 52 in the positioning tag 5. For example, the computer program 52 can be divided into a first processing unit, a second processing unit, a calculating unit, and a determining unit.

The first processing unit is configured to broadcast a ranging request frame to at least two of the positioning anchors and record a first timestamp of broadcasting the ranging request frame;

The second processing unit is configured to receive a ranging reply frame corresponding to the ranging request frame from each of the at least two positioning anchors and record a second timestamp of receiving the ranging reply frame, where the ranging reply frame includes anchor information of the positioning anchor and a time difference between the positioning anchor to receive the ranging request frame and the positioning anchor to transmit the ranging reply frame;

The calculating unit is configured to calculate a distance between the positioning anchor and the positioning tag transmitting the ranging request frame based on the first timestamp, the second timestamp, and the time difference in the ranging reply frame; and

The determining unit is configured to determine position information of the positioning tag based on the anchor information in the ranging reply frame and the distance.

It can be understood by those skilled in the an that FIG. 6 is merely an example of the positioning tag 5 and does not constitute a limitation on the positioning tag 5, and may include more or fewer components than those shown in the figure, or a combination of some components or different components. For example, the wireless positioning apparatus 5 may further include an input/output device, a network access device, a bus, and the like.

The processor 50 may be a central processing unit (CPU), or be other general purpose processor, a digital signal processor (DSP), an application specific integrated circuit (ASIC), a field-programmable gate array (FPGA), or be other programmable logic device, a discrete gate, a transistor logic device, and a discrete hardware component. The general purpose processor may be a microprocessor, or the processor may also be any conventional processor.

The storage 51 may be an internal storage unit of the positioning tag 5, for example, a hard disk or a memory of the positioning tag 5. The storage 51 may also be an external storage device of the positioning tag 5. for example, a plug-in hard disk, a smart media card (SMC), a secure digital (SD) card, flash card, and the like, which is equipped on the positioning tag 5. Furthermore, the storage 51 may further include both an internal storage unit and an external storage device, of the positioning tag 5. The storage 51 is configured to store the computer program 52 and other programs and data required by the positioning tag 5. The storage 51 may also be used to temporarily store data that has been or will be output.

As shown in FIG. 6, in this embodiment, the positioning anchor 6 includes a processor 60, a memory 61, and a computer program 62 stored in the memory 61 and executable on the processor 60, for example, a wireless positioning program, and a wireless communication unit 63 (e.g., a UWB RF module) for communicating with the positioning tag 5. When executing (instructions in) the computer program 62, the processor 60 implements the steps in the above-mentioned embodiments of the wireless positioning method, for example, steps S201-S203 shown in FIG. 3. Alternatively, when the processor 60 executes the (instructions in) computer program 62, the functions of each module/unit in the above-mentioned device embodiments, for example, the functions of the modules 410-430 shown in FIG. 5 are implemented.

Exemplarily, the computer program 62 may be divided into one or more modules/units, and the one or more modules/units are stored in the storage 61 and executed by the processor 60 to realize the present disclosure. The one or more modules/units may be a series of computer program instruction sections capable of performing a specific function, and the instruction sections are for describing the execution process of the computer program 62 in the positioning anchor 6. For example, computer program 62 can be divided into a fourth processing unit, a fifth processing unit, and a return unit, and the functions of each unit are as follows.

The fourth processing unit is configured to receive a ranging request frame broadcasted by the positioning tag, and recording a third timestamp of receiving the ranging request frame, where the ranging request frame includes identifier information of the positioning tag and lime information corresponding to a communication time slot.

The fifth processing unit is configured to obtain an anchor identifier of the anchor itself, and determining a time for transmitting a ranging reply frame for the positioning tag to determine position information of the positioning tag based on the anchor identifier and the time information corresponding to the communication time slot.

The returning unit is configured to transmit the ranging reply frame to the positioning tag based on the identifier information of the positioning tag if a current time is determined to be the time for transmitting the ranging reply frame, where the ranging reply frame includes anchor information of the positioning anchor itself, the third timestamp, a fourth timestamp of transmitting the ranging reply frame, and a time difference between the fourth timestamp and the third timestamp.

It can be understood by those skilled in the art that FIG. 6 is merely an example of the positioning anchor 6 and does not constitute a limitation on the positioning anchor 6, and may include more or fewer components than those shown in the figure, or a combination of some components or different components. For example, the positioning anchor 6 may further include an input/output device, a network access device, a bus, and the like.

The processor 60 may be a central processing unit (CPU), or be other general purpose processor, a digital signal processor (DSP), an application specific integrated circuit (ASIC), a field-programmable gate array (FPGA), or be other programmable logic device, a discrete gate, a transistor logic device, and a discrete hardware component. The general purpose processor may he a microprocessor, or the processor may also be any conventional processor.

The storage 61 may be an internal storage unit of the positioning anchor 6, for example, a hard disk or a memory of the positioning anchor 6. The storage 61 may also be an external storage device of the positioning anchor 6, for example, a plug-in hard disk, a smart media card (SMC), a secure digital (SD) card, flash card, and the like, which is equipped on the positioning anchor 6. Furthermore, the storage 61 may further include both an internal storage unit and an external storage device, of the positioning anchor 6. The storage 61 is configured to store the computer program 62 and other programs and data required by the positioning anchor 6. The storage 61 may also be used to temporarily store data that has been or will be output.

Those skilled in the art may clearly understand that, for the convenience and simplicity of description, the division of the above-mentioned functional units and modules is merely an example for illustration. In actual applications, the above-mentioned functions may be allocated to be performed by different functional units according to requirements, that is, the internal structure of the device may be divided into different functional units or modules to complete all or part of the above-mentioned functions. The functional units and modules in the embodiments may be integrated in one processing unit, or each unit may exist alone physically, or two or more units may be integrated in one unit. The above-mentioned integrated unit may be implemented in the form of hardware or in the form of software functional unit. In addition, the specific name of each functional unit and module is merely for the convenience of distinguishing each other and are not intended to limit the scope of protection of the present disclosure. For the specific operation process of the units and modules in the above-mentioned system, reference may be made to the corresponding processes in the above-mentioned method embodiments, and are not described herein.

In the above-mentioned embodiments, the description of each embodiment has its focuses, and the parts which are not described or mentioned in one embodiment may refer to the related descriptions in other embodiments.

Those ordinary skilled in the art may clearly understand that, the exemplificative units and steps described in the embodiments disclosed herein may be implemented through electronic hardware or a combination of computer software and electronic hardware. Whether these functions are implemented through hardware or software depends on the specific application and design constraints of the technical schemes. Those ordinary skilled in the art may implement the described functions in different manners for each particular application, while such implementation should not be considered as beyond the scope of the present disclosure.

In the embodiments provided by the present disclosure, it should be understood that the disclosed apparatus/system and method may be implemented in other manners. For example, the above-mentioned apparatus/system embodiment is merely exemplary. For example, the division of modules or units is merely a logical functional division, and other division manner may be used in actual implementations, that is, multiple units or components may be combined or be integrated into another system, or some of the features may be ignored or not performed. In addition, the shown or discussed mutual coupling may be direct coupling or communication connection, and may also be indirect coupling or communication connection through some interfaces, devices or units, and may also be electrical, mechanical or other forms.

The units described as separate components may or may not be physically separated. The components represented as units may or may not be physical units, that is, may be located in one place or be distributed to multiple network units. Some or all of the units may be selected according to actual needs to achieve the objectives of this embodiment.

In addition, each functional unit in each of the embodiments of the present disclosure may be integrated into one processing unit, or each unit may exist alone physically, or two or more units may be integrated in one unit. The above-mentioned integrated unit may be implemented in the form of hardware or in the form of software functional unit.

When the integrated module/unit is implemented in the form of a software functional unit and is sold or used as an independent product, the integrated module/unit may be stored in a non-transitory computer-readable storage medium. Based on this understanding, all or part of the processes in the method for implementing the above-mentioned embodiments of the present disclosure are implemented, and may also be implemented by instructing relevant hardware through a computer program. The computer program may be stored in a non-transitory computer-readable storage medium, which may implement the steps of each of the above-mentioned method embodiments when executed by a processor. In which, the computer program includes computer program codes which may be the form of source codes, object codes, executable files, certain intermediate, and the like. The computer-readable medium may include any primitive or device capable of carrying the computer program codes, a recording medium, a USB flash drive, a portable hard disk, a magnetic disk, an optical disk, a computer memory, a read-only memory (ROM), a random access memory (RAM), electric carrier signals, telecommunication signals and software distribution media. It should be noted that the content contained in the computer readable medium may be appropriately increased or decreased according to the requirements of legislation and patent practice in the jurisdiction. For example, in some jurisdictions, according to the legislation and patent practice, a computer readable medium does not include electric carrier signals and telecommunication signals.

The above-mentioned embodiments are merely intended for describing but not for limiting the technical schemes of the present disclosure. Although the present disclosure is described in detail with reference to the above-mentioned embodiments, it should be understood by those skilled in the art that, the technical schemes in each of the above-mentioned embodiments may still be modified, or some of the technical features may be equivalently replaced, while these modifications or replacements do not make the essence of the corresponding technical schemes depart from the spirit and scope of the technical schemes of each of the embodiments of the present disclosure, and should be included within the scope of the present disclosure.

1. A computer-implemented wireless positioning method for a wireless positioning system having at least a positioning tag and a plurality of positioning anchors, comprising the steps of:
broadcasting, by the positioning tag, a ranging request frame to at least two of the positioning anchors and recording, by the positioning tag, a first timestamp of broadcasting the ranging request frame, in response to having detected a positioning request;
receiving, by the at least two of the positioning anchors, the ranging request frame broadcasted by the positioning tag, and recording, by the at least two of the positioning anchors, a third timestamp of receiving the fanning request frame, wherein the ranging request frame comprises identifier information of the positioning tag and time information corresponding to a communication time slot;
receiving, by the positioning tag, in a time slot, a first ranging reply frame corresponding to the ranging request frame from one of the at least two positioning anchors and recording, by the positioning tag, a second timestamp of receiving the first ranging reply frame, wherein the first ranging reply frame comprises anchor information of said one of the positioning anchors and a time difference between the third timestamp of said one of the at least two positioning anchors and a fourth timestamp of said one of the at least two of the positioning anchors transmitting the first ranging reply frame;
calculating, by the positioning tag, a first distance between said one of the positioning anchors and the positioning tag transmitting the ranging request frame based on the first timestamp, the second timestamp, and the time difference in the first ranging reply frame,
receiving, by the positioning tag, in another time slot, a second ranging reply frame from another one of the at least two positioning anchors and recording, by the positioning tag, the second timestamp of receiving the second ranging reply frame, wherein the second ranging reply frame comprises anchor information of said another one of the at least two positioning anchors and a time difference between the third timestamp of said another one of the positioning anchors and the fourth timestamp of said another one of the positioning anchors transmitting the second ranging reply frame;
calculating, by the positioning tag, a second distance between said another one of the positioning anchors and the positioning tag transmitting the ranging request frame based on the first timestamp, the third timestamp, and the time difference in the second ranging reply frame; and
determining, by the positioning tag, position information of the positioning tag based on the anchor information in the ranging reply frames and the distances.

2. The method of claim 1, wherein if the number of the positioning anchor is three and the three positioning anchors are not on a same straight line, the step of determining, by the positioning tag, the position information of the positioning tag based on the anchor information in the ranging reply frames and the distances comprising:
calculating, by the positioning tag, the position information of the positioning tag based on the anchor information in the ranging reply frames and the distances through a triangulation method.

3. The method of claim 1, the step of calculating, by the positioning tag, the first distance between said one of the positioning anchors and the positioning tag transmitting the ranging request frame based on the first timestamp, the second timestamp, and the time difference in the first ranging reply frame comprising:
transmitting, by the positioning tag, the anchor information of said one of the positioning anchors and the first distance to one of a positioning anchor and a server in the wireless positioning system, wherein the anchor information of said one of the positioning anchors and the first distance are for determining the position information of the positioning tag.

4. The method of claim 1, further comprising:
making, by the positioning tag, the positioning tag to enter a sleep state, in response to having detected the position information of the positioning tag.

5. (canceled)

6. The method of claim 1, wherein further comprising:
receiving, by each of the positioning anchors, the anchor information of all the positioning anchors except the positioning anchor itself and a distance between the positioning anchor and the positioning tag from the positioning tag; and
determining, by each of the positioning anchors, the position information of the positioning tag based on the anchor information of the positioning anchor in the ranging reply frame and the distance.

7. A wireless positioning system having at least a positioning tag and a plurality of positioning anchors, wherein the positioning tag comprises:
a communication circuit configured to communicate with the positioning anchors in a wireless manner;
a memory;
a processor; and
one or more computer programs stored in the memory and executable on the processor, wherein the one or more computer programs comprise:
instructions for broadcasting a ranging request frame to at least two of the positioning anchors and recording a first timestamp of broadcasting the ranging request frame, in response to having detected a positioning request;
instructions for receiving, in a time slot, a first ranging reply frame corresponding to the ranging request frame from one of the at least two positioning anchors and recording, by the positioning tag, a second timestamp of receiving the first ranging reply frame, wherein the first ranging reply frame comprises anchor information of said one of the positioning anchors and a time difference between a third timestamp of said one of the at least two positioning anchors receiving the ranging request frame and a fourth timestamp of said one of the at least two of the positioning anchors transmitting the first ranging reply frame;
instructions for calculating a first distance between said one of the positioning anchors and the positioning tag transmitting the ranging request frame based on the first timestamp, the second timestamp, and the time difference in the first ranging reply frame;
instructions for receiving, in another time slot, a second ranging reply frame from another one of the at least two positioning anchors and recording, by the positioning tag, the second timestamp of receiving the second ranging reply frame, wherein she second ranging reply frame comprises anchor information of said another one of the at least two positioning anchors and a time difference between the third timestamp of said another one of the positioning anchors receiving the ranging request frame and the fourth timestamp of said another one of the positioning anchors transmitting the second ranging reply frame;
instructions for calculating, a second distance between said another one of the positioning anchors and the positioning tag transmitting the ranging request frame based on the first timestamp, the third timestamp, and the time difference the second ranging reply frame; and
instructions for determining position information of the positioning tag based on the anchor information in the ranging reply frames and the distances;
the positioning anchors each comprises:
a communication circuit configured to communicate with the positioning tag in a wireless manner,
a memory,
a processor; and
one or more computer programs stored in the memory and executable on the processor, wherein the one or more computer programs comprise:
instructions for receiving the ranging request frame broadcasted by the positioning tag, and recording the third timestamp of receiving the ranging request frame, wherein the ranging request frame comprises identifier information of the positioning tag and time information corresponding to a communication time slot;
instructions for obtaining an anchor identifier of the anchor itself, and determining a time for transmitting the ranging reply frame for the positioning tag to determine the position information of the positioning tag based on the anchor identifier and the time information corresponding to the communication time slot; and
instructions for transmitting the ranging reply frame to the positioning tag based on the identifier information of the positioning tag in response to determining a current time being the time for transmitting the ranging reply frame, wherein the ranging reply frame comprises the anchor information of the positioning anchor itself, the third timestamp, a fourth timestamp of transmitting the ranging reply frame, and the time difference between the fourth timestamp and the third timestamp.

8. The system of claim 7, wherein the instructions for determining the position information of the positioning tag based on the anchor information in the ranging reply frames and the distances comprise:
instructions for calculating the position information of the positioning tag based on the anchor information in the ranging reply frame and the distance through a triangulation method.

9. The system of claim 7, wherein the instructions for calculating the first distance between said one of the positioning anchors and the positioning tag transmitting the ranging request frame based on the first timestamp, the second timestamp, and the time difference in the first ranging, reply frame comprise:
instructions for transmitting the anchor information of said one of the positioning anchors and the first distance to one of a positioning anchor and a server in the wireless positioning system, wherein the anchor information of said one of the positioning anchors and the first distance are for determining the position information of the positioning tag.

10. The system of claim 7, wherein the one or more computer programs of the positioning tag further comprise:
instructions for making the positioning tag to enter a sleep state, in response to having detected the position information of the positioning tag.

11. The system of claim 7, wherein the one or more computer programs of each positioning anchor further comprise:
instructions for receiving the anchor information of all the positioning anchors except each of the positioning anchors itself and a distance between the positioning anchor and the positioning tag from the positioning tag; and
instructions for determining the position information of the positioning tag based on the anchor information of each of the positioning anchors in the ranging reply frame and the distance.

12. The method of claim 1, wherein the anchor information of each positioning anchor comprises identifier information of the positioning anchor itself, and the method further comprises:
determining, by the positioning tag, which of the time slots the positioning anchors occupy according to the identifier information of the positioning anchors.

13. The method of claim 1, wherein the anchor information of each positioning anchor comprises identifier information of the positioning anchor itself, and the method further comprises:
determining, by the positioning tag, which of the time slots the positioning anchors occupy according to the remainder of the identifier information of the positioning anchors divided by N, wherein N is the number of the positioning anchors that take part in one ranging.

14. The method of claim 1, wherein the time information includes a duration of the communication time slot.

15. The method of claim 1, wherein the distance between the positioning anchor and the positioning tag transmitting the ranging request frame can be calculated by the following formula:
d=(Tsr−Tsp−(Tsq−Trp))×C/2
where, d is the distance between the positioning anchor and the tag transmitting the ranging request frame; (Tsq−Trp) is the time difference between the third timestamp and the fourth timestamp; Tsr is the second timestamp; and Tsp is the first timestamp, (Tsr−Tsp−(Tsq−Trp)) is the time for the wifeless signal between the positioning anchor and the tag transmitting the ranging request frame to be transmitted in the air; and C is the speed of light.

16. The system of claim 7, wherein the one or more computer programs of the positioning tag further comprise:
instructions for determining which of the time slots the positioning anchors occupy according to the identifier information of the positioning anchors.

17. The system of claim 16, wherein the one or more computer programs of the positioning tag further comprise:
instructions for determining which of the time slots the positioning anchors occupy according to the remainder of the identifier information of the positioning anchors divided by N, wherein N is the number of the positioning anchors that take part in one ranging.

18. The system of claim 7, wherein the communication circuit of the positioning tag is a wireless communication module.

19. The system of claim 7, wherein the time information includes a duration of the communication time slot.

20. The system of claim 7, wherein the distance between the positioning anchor and the positioning tag transmitting the ranging request frame can be calculated by the following formula:
d=(Tsr−Tsp−(Tsq−Trp))×C/2;
where, d is (he distance between the positioning anchor and the tag transmitting the ranging request frame; (Tsq−Trp) is the time difference between the third timestamp and the fourth timestamp; Tsr is the second timestamp; and Tsp is the first timestamp; (Tsr−Tsp−(Tsq−Trp)) is the time for the wireless signal between the positioning anchor and the fag transmitting the ranging request frame to be transmuted in the air; and C is the speed of light.
